(19) United States
(12) Patent Application Publication
(10) Pub. No.: US 2007/0256363 A1
(43) Pub. Date: Nov. 8, 2007

(54) Access door

(75) Inventors: Christopher A. Hord, Vancouver, WA (US); Christoper L. Zook, Clackamas, OR (US); Michael S. Farley, Gresham, OR (US)

Correspondence Address: MCNEES WALLACE & NURICK LLC, 100 PINE ST., P.O. BOX 1166, HARRISBURG, PA, 17108-1166, US

(73) Assignee: YORK INTERNATIONAL CORPORATION, York, PA (US)

(21) Appl. No.: 11/272,170

(22) Filed: Nov. 10, 2005

(51) Int. Cl. E06B 5/00; E06B 7/16

(52) U.S. Cl. 49/381; 29/700; 49/475.1

(57) ABSTRACT

A structural member is provided for constructing a door. The structural member includes a first end portion, a second end portion disposed opposite the first end portion and a web disposed between the first end portion and the second end portion. A channel is disposed between the web and the second end portion, the first end portion being configured to receive a portion of a first door panel to permit the first door panel to be connected to the structural member. The second end portion is configured to receive a portion of a second door panel to permit the second door panel to be connected to the structural member. The channel is configured to receive a peripheral portion of the second door panel, the first and second door panels to be connected to the first and second end portions without mechanical fasteners.

### FIELD OF THE INVENTION

The present invention is directed to a door or wall, and more particularly, is directed to a structural member for use with a door or wall of an air handling unit.

### BACKGROUND OF THE INVENTION

Air handling units typically require doors to access components housed in an air handling unit compartment. One method of manufacturing these doors includes providing a structural member that is cut into segments that are abutted at their ends to form the framework of the door, typically a rectangle. To help secure the structural members in position to form the framework, mechanical fasteners, such as screws, are driven through the corner edge of one structural member and into the corner edge of another structural edge of an adjacent structural member. Door panels are then secured to each side of the framework to form a door. The ends of the structural member typically include a pair of slots that are each parallel to or perpendicular to a web of the structural member with which to receive the periphery of the door panels, depending upon the configuration of the door panels. For example, if each of the panels is planar, the slots for receiving the door panel peripheries are perpendicular to the web of the structural member. However, if the peripheries of the door panels include bent-up flanges so that the door panels resemble a “cake pan,” the slots for receiving the door panel peripheries are parallel to the web of the structural member. Alternately, instead of slots, each of the ends of the structural member may include a pair of flat or curved edges that are overlain by the peripheries of the door panels.

In either construction, the structural members do not readily accommodate dimensional differences or tolerances that result during fabrication of the individual door panels. Further, the door panels are secured to the structural members by additional mechanical fasteners, such as screws or other blind side fasteners. Installing these fasteners is a manual process, further increasing the cost of the door.

What is needed is a structural member that does not require mechanical fasteners and readily accommodates dimensional tolerances between door panels.

### SUMMARY OF THE INVENTION

The present invention relates to a structural member for constructing a door. The structural member includes a first end portion, a second end portion disposed opposite the first end portion and a web disposed between the first end portion and the second end portion. A channel is disposed between the web and the second end portion, the first end portion being configured to received a portion of a first door panel to permit the first door panel to be connected to the structural member. The second end portion is configured to receive a portion of a second door panel to permit the second door panel to be connected to the structural member. The channel is configured to receive a peripheral portion of the second door panel, the first and second door panels to be connected to the first and second end portions without mechanical fasteners.

The present invention further relates to a door assembly for an air handling unit. The door assembly includes a frame connectable to the air handling unit and a door hingedly connected to the frame, the door comprises a first door panel, a second door panel and a framework including at least one structural member. The at least one structural member includes a first portion and a second portion opposite the first portion and a web disposed between the first portion and the second portion. The at least one structural member further includes a channel disposed between the web and the second portion. A portion of a periphery of the first door panel is secured to the first portion without mechanical fasteners. A portion of the second door panel is secured to the second portion without mechanical fasteners. A peripheral portion of the second door panel is disposed in the channel.

The present invention still further relates to a method for assembling an air handler unit door. The method includes providing a frame connectable to the air handling unit and providing a door hingedly connected to the frame, the door comprises a first door panel, a second door panel and a framework including at least one structural member. The method further includes providing the at least one structural member including a web having a first portion and a second portion opposite the first portion. A channel is disposed between the web and the second portion, the channel being non-parallel to the first portion. The method further includes securing a first door panel to the first portion without mechanical fasteners, wherein a portion of the first door panel overlies the first portion; and securing a second door panel to the second portion without mechanical fasteners, wherein a portion of the second door panel is disposed in the channel.

An advantage of the present invention is that it is inexpensive to manufacture.

A further advantage of the present invention is that it requires fewer parts.

A still further advantage of the present invention is that it does not require mechanical fasteners.

An additional advantage of the present invention is that a structural member disposed between two door panels is configured to accommodate dimensional variations of the door panels.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIGS. 1 and 2 are opposed perspective views of a door frame including an installed door of the present invention.

FIGS. 3 and 4 are each cross-sections of a door taken along line 3-3 of the present invention.

FIG. 5 is a cross-section of an outswing door in its closed position within the door frame of the present invention.

FIGS. 6-7 are perspective views of embodiments of a handle support piece of the present invention.

FIG. 8 is a cross-section of an inswing door in its closed position within the door frame of the present invention.

Wherever possible, the same reference numbers will be used throughout the drawings to refer to the same or like parts. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE INVENTION

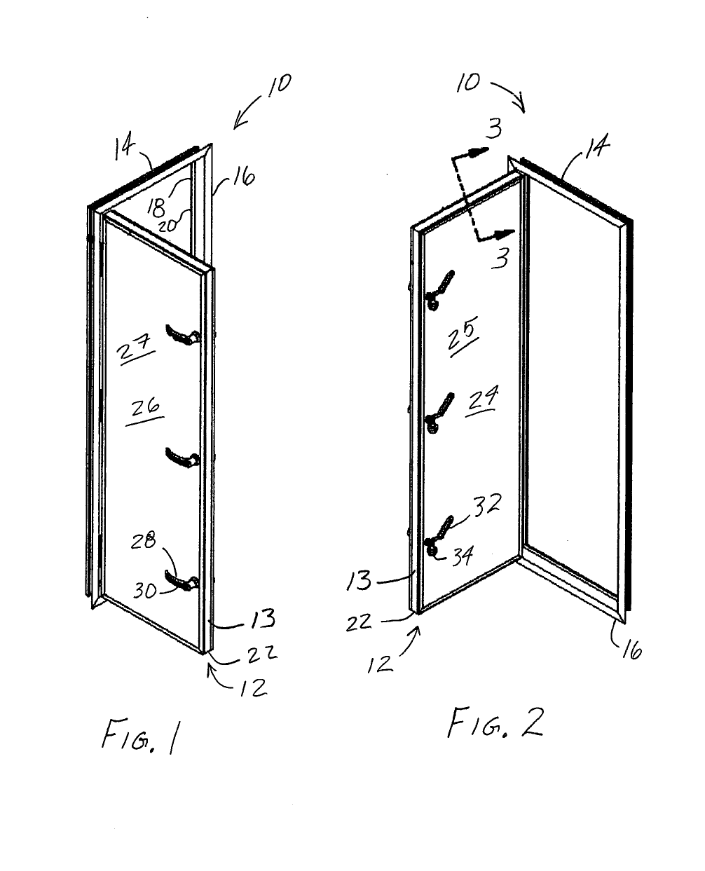

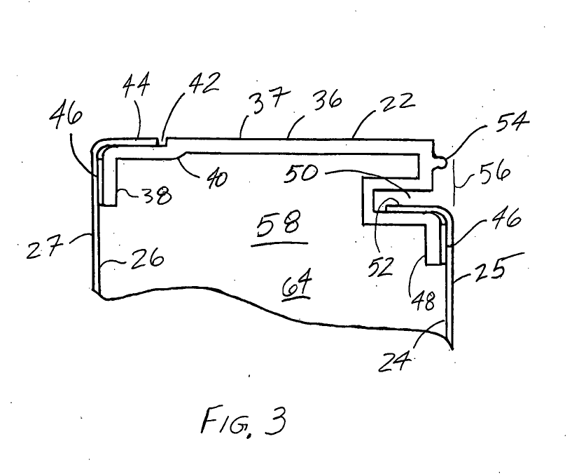

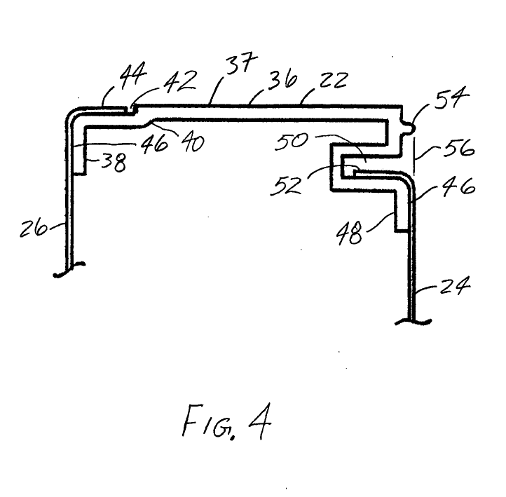

One embodiment of a door 12 is shown in FIGS. 1 and 2. Preferably, door 12 is used to access an interior of an air handling unit (not shown). The door 12 is hingedly connected to a frame 14. The frame 14 is typically secured to the air handling unit by fasteners (not shown) driven through both an internal flange 16 of the frame 14 and a wall of the air handling unit. The periphery of the door 12 preferably includes four segments of a structural member 22 that mutually abut at the ends of adjacent segments to form a rectangular framework 13. Each corner of the rectangular framework 13 of door 12 is defined by chamfering the ends of the two corresponding adjacent segments prior to assembly. Once the rectangular framework 13 is assembled, an inner panel 24 is secured to one side of the framework 13, and an outer panel 26 is secured to the other side of the framework 13. The door 12 is placed in a press (not shown) that applies an inwardly directed clamping force to opposite portions of the framework 13 to draw or position the inner and outer panels 24, 26 against the framework 13. As discussed in further detail below, the inner and outer panels 24, 26 are secured to the opposite portions of the framework 13 without requiring mechanical fasteners. Additionally, the press provides structural support to opposed outwardly facing surfaces 25, 27 of the respective inner and outer panels 24, 26 so that insulating material 64 (see FIG. 3) under pressure, such as polyurethane foam, is injected inside a chamber 58 (see FIG. 3) defined by the framework 13 of structural members 22 and the inner and outer panels 24, 26.

Referring to FIGS. 3-5, the structural member 22 includes a web 36 that extends to an outer flange 38 at one end to receive a flange or lip 44 of outer panel 26. The lip 44 of outer panel 26 extends at an angle from the remaining portions of the outer panel 26, defining a “cake pan” shape. Preferably, lip 44 is substantially perpendicular to the remaining portions of the outer panel 26. The outer flange 38 preferably includes a recess 42 so that upon assembly of the lip 44 of the outer panel 26 to the outer flange 38, the lip 44 is substantially flush with an exterior surface 37 of web 36. Optionally, recess 42 is formed from plate stock by a machining operation performed either before or after forming the outer flange 38, such as by bending the plate stock, forming a joggle 40 adjacent the junction disposed between the web 36 and the outer flange 38, or by forming the structural member 22 as an extrusion.

At the end of the web 36 opposite the outer flange 38 extends an inner flange 48 that is substantially parallel to the outer flange 38. Disposed between the inner flange 48 and web 36 is a channel 50 for receiving a flange or lip 52 of the inner panel 24. The lip 52 of inner panel 24 extends at an angle from the remaining portions of the inner panel 24, defining a “cake pan” shape, similar to the outer panel 26. Preferably, lip 52 is substantially perpendicular to the remaining portions of the inner panel 24. The opening of channel 50 is larger than the thickness of the lip 52. The large opening of the channel 50 as compared to the thickness of the lip 52 simplifies insertion of the lip 52 inside the channel 50. Additionally, the channel 50 opening is sized to accommodate for dimensional and/or angular deviations of the panel 24 from the nominal design dimensions and angles, also referred to as tolerance build-up. In other words, although the distance between lips 52 of the respective panel 24 can fluctuate, as can the angle between each lip 52 and the respective panel 24, by virtue of the large opening of the channel 50, the lips 52 can still be inserted inside channel 50. This adjustment feature of the channel 50 provides ease of manufacturability as well as a pleasing appearance.

To secure the inner and outer panels 24, 26 to their respective inner and outer flanges 48, 38, preferably a layer of tape 46 having an adhesive applied to the opposed surfaces of the tape 46 is disposed between the inner panel 24 and the inner flange 48 and between the outer panel 26 and the outer flange 38. More preferably, tape 46 is disposed between portions of the inner panel 24 and the inner flange 48 and between the outer panel 26 and the outer flange 38 such that once the assembled door 12 is inserted into the press, the inwardly directed clamping force that is applied by the press to the opposed outward facing surface 27 of the outer panel 26 and the outward facing surface 25 of the inner panel 24 compresses the tape 46. Stated another way, the tape 46 is preferably disposed between portions of the outer and inner flanges 38, 48 that are parallel to each other, so that the compressive forces applied by the press to the door panels 24, 26 compress the tape 46 to secure the door panels 24, 26 to the respective flanges 48, 38. By virtue of the compressive forces applied by the press, the bond between the door panels 24, 26 and the respective flanges 48, 38 of the structural member 22 is enhanced, permitting a door construction that does not require mechanical fasteners, such as rivets, screws, clamps, nuts and bolts or other fastening methods known in the art. Additionally, the tape 46 can be applied as part of an automated process, while typically, mechanical fasteners must be manually installed. It is to be understood that other automated means, such as adhesive or pressure activated bonding process can also be applied directly to either or both of the corresponding portions of the door panels 24, 26 and flanges 48, 38 of the structural member 22.

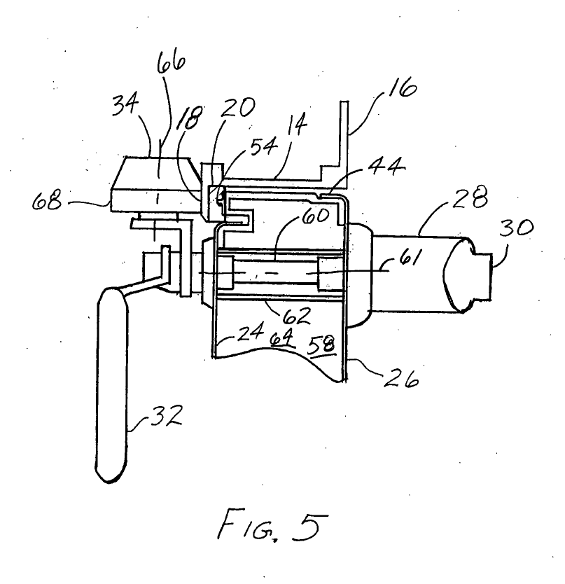

Referring to FIGS. 3-5 and 8, the structural member 22 preferably includes a protrusion 54 that is disposed between the web 36 and the channel 50. As shown in FIG. 5, the protrusion 54 abuts a resilient gasket 20 secured to an internal flange 18 of the door frame 14, providing a substantially fluid tight seal between the door frame 14 and door 12. To ensure that the fluid tight seal is achieved and maintained when the door is in its closed position, a conical cam 34 or similarly configured tapered member is provided. The conical cam 34 is disposed at a fixed angular orientation to each of an internal handle 32 and an external handle 30 about an axis 61 defined by a latch shaft 60 so that rotatably actuating either handle 30, 32, similarly rotates the conical cam 34 about the axis 61. Upon the conical cam 34 being rotated in one direction with the door 12 in a closed position, the tapered profile of the conical cam 34 engages the internal flange 18 of the door frame 14 opposite the gasket 20. Further actuation of the tapered conical cam 34 places a portion of the conical cam 34 having an increased radius from a center axis 66 against internal flange 18, forcibly directing the internal flange 18 and gasket 20 in a direction toward the door 12. Simultaneously, the protrusion 54 of the door is urged into an increasing compressive contact with the gasket 20. A maximum compressive contact between the protrusion 54 and the gasket 20 occurs when a base 68 of the conical cam 34 is rotated into contact with the internal flange 18 of door frame 14. FIG. 5 shows an outswing door, in which the door swings exterior of the air handling unit, while FIG. 8 shows an inswing door, in which the door swings interior of the air handling unit. In FIG. 5 the conical cam 34 is adjacent the internal handle 32, while in FIG. 8, the conical cam 34 is adjacent the external handle 30.

Preferably, the protrusion 54 is recessed with respect to the outwardly facing surface 25 of the inner panel 24, such as defined by plane 56 (FIG. 3), when the inner panel 24 is initially assembled to the inner flange 48. After the door 12 has been placed in the press and subjected to the compressive clamping forces generated by the press (FIG. 4), the thickness of the tape 46 disposed between the panels 26, 24 and respective flanges 38, 48 of the structural member 22, is reduced. However, the protrusion 54 remains recessed with respect to the outwardly facing surface 25, or can also be substantially flush with the outwardly facing surface 25, so that the protrusion 54 is not damaged during operation of the press. Otherwise, special provisions must be made upon insertion of the door 12 in the press, such as the provision of spacers (not shown) along the inner flange 48 or specially configuring the press so that the protrusion 54 does not contact surfaces of the press that contact the door panel surfaces, which special configuring of the press additionally requires precise installation and alignment of the door 12 within the press.

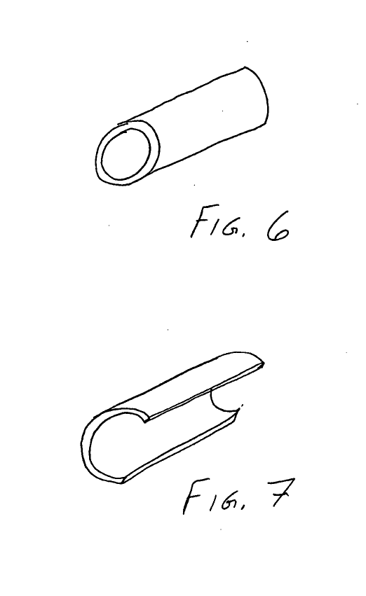

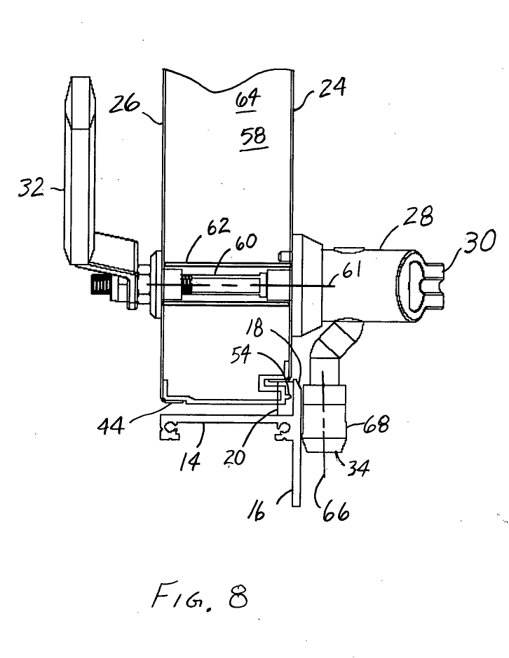

As shown in FIGS. 5-7, an additional aspect of the present includes a handle support piece 62 that is preferably disposed substantially concentrically with respect to the axis 61 corresponding to the latch shaft 60. The support piece 62, which can be a tube of any closed geometry, and alternately, any open geometry (e.g., FIG. 7) so long as the geometry provides structural support parallel to the axis 61 to prevent inadvertent over-tightening of the components associated with the door latch 28. Such over-tightening can draw the opposed panels 24, 26 toward each other, resulting in decreased insulative performance by the door, and also detracting from the appearance of the door.

Although the embodiments of the present invention have been directed to doors, those skilled in the art can appreciate that the present invention can also be used to construct walls. Further, although the embodiments have been directed to four structural members forming rectangular doors or walls, a door or wall can be constructed of a single curved structural member, or more than four structural members.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A structural member for constructing a door comprising:
a first end portion, a second end portion disposed opposite the first end portion and a web disposed between the first end portion and the second end portion;
a channel disposed between the web and the second end portion, the first end portion being configured to received a portion of a first door panel to permit the first door panel to be connected to the structural member;
the second end portion being configured to receive a portion of a second door panel to permit the second door panel to be connected to the structural member; and
wherein the channel is configured to receive a peripheral portion of the second door panel, the first and second door panels to be connected to the first and second end portions without mechanical fasteners.

2. The structural member of claim 1 wherein the first end portion and the second end portion are substantially parallel to each other.

3. The structural member of claim 1 wherein the first end portion has a recess configured to receive the portion of the first door panel.

4. The structural member of claim 1 comprises a protruding portion disposed between the channel and the web.

5. The structural member of claim 4 wherein the protruding portion is configured to be recessed from an exterior surface of the second door panel upon connection to the second end portion.

6. The structural member of claim 4 wherein the protruding portion is configured to be substantially coplanar with an exterior surface of the second door panel upon connection to the second end portion.

7. The structural member of claim 1 wherein the first end portion includes a first flange disposed at an angle to the web.

8. The structural member of claim 7 wherein the second end portion includes a second flange disposed at an angle to the web.

9. The structural member of claim 8 wherein the first flange and second flange are substantially parallel to each other.

10. The structural member of claim 9 wherein the first flange and second flange are each substantially perpendicular to the web.

11. A door assembly for an air handling unit comprising:
a frame connectable to the air handling unit;
a door hingedly connected to the frame, the door comprises a first door panel, a second door panel and a framework including at least one structural member;
the at least one structural member comprising:
a first portion and a second portion opposite the first portion and a web disposed between the first portion and the second portion; and
a channel disposed between the web and the second portion; and
a portion of a periphery of the first door panel is secured to the first portion without mechanical fasteners;
a portion of the second door panel is secured to the second portion without mechanical fasteners; and
wherein a peripheral portion of the second door panel is disposed in the channel.

12. The door assembly of claim 11 wherein the first portion and the second portion are substantially parallel to each other.

13. The door assembly of claim 11 wherein the first door panel comprises a flange portion disposed substantially perpendicular to the portion of the first door panel connected to the first portion.

14. The door assembly of claim 13 wherein the first portion has a recess for receiving the flange portion of the first door panel.

15. The door assembly of claim 11 wherein the first door panel is secured to the first portion and the second door panel is secured to the second portion with an adhesive.

16. The door assembly of claim 15 wherein the adhesive is provided by a tape having a layer of adhesive applied to each side of the tape, the tape being disposed between the first door panel and the first portion, and between the second door panel and the second portion.

17. The door assembly of claim 11 comprises a protruding portion disposed between the channel and second end portion.

18. The door assembly of claim 11 wherein the first portion includes a first flange disposed at an angle to the web and the second portion includes a second flange protruding at an angle to the web, the first flange and second flange being substantially parallel to each other, and the first flange and second flange each being substantially perpendicular to the web.

19. The door assembly of claim 11 wherein a peripheral portion of the second door panel is disposed substantially perpendicular to the portion of the second door panel connected to the second portion;
the frame comprises a flange;
the door comprises a handle with a cam, wherein upon actuation of the handle, the cam contacts the flange to urge the door toward the frame; and
a gasket disposed between the door and the frame to effect a substantially fluid tight seal between the door and the frame when the door is sufficiently urged toward the frame.

20. The door assembly of claim 11 wherein the channel is configured to accommodate deviations from a set of nominal values of the second door panel.

21. A method for assembling an air handler unit door comprising:
providing a frame connectable to the air handling unit;
providing a door hingedly connected to the frame, the door comprises a first door panel, a second door panel and a framework including at least one structural member;
providing the at least one structural member comprising:
a web having a first portion and a second portion opposite the first portion;
a channel disposed between the web and the second portion, the channel being non-parallel to the first portion; and
securing a first door panel to the first portion without mechanical fasteners, wherein a portion of the first door panel overlies the first portion; and
securing a second door panel to the second portion without mechanical fasteners, wherein a portion of the second door panel is disposed in the channel.

22. The method of claim 21 wherein the steps of securing a first door panel and a second door panel includes
disposing a tape between the first door panel and the first portion, and between the second door panel and the second portion, the tape having a layer of adhesive applied to each side of the tape, and
applying a force to the first and second door panels to compress the tape.

23. The method of claim 21 wherein the steps of securing a first door panel and a second door panel includes the step of injecting insulative material inside a chamber defined by the first door panel, the second door panel and the at least one structural member.

24. The method of claim 21 further comprising the step of installing a handle support piece between the first door panel and second door panel for preventing the first door panel and second door panel from being drawn too closely together during installation of a latch through the first and second door panels.

25. The method of claim 21 wherein the steps of securing a first door panel and a second door panel includes the step of providing a first peripheral flange for the first door panel and a second peripheral flange for the second door panel;
securing the first peripheral flange to the first portion;
securing the second peripheral flange to the second portion; and
inserting a portion of the second peripheral flange inside the channel.
